(19) United States
(12) Patent Application Publication
(10) Pub. No.: US 2012/0194053 A1
(43) Pub. Date: Aug. 2, 2012

(54) HINGE, SLIDING ASSEMBLY AND PORTABLE DEVICE

(76) Inventors: Chia-Hao HSU, New Taipei City (TW); Yu-Feng Lin, New Taipei City (TW); Kuan-Chih Chen, New Taipei City (TW); Chia-Chun Yuan, New Taipei City (TW); Che-Yu Chou, New Taipei City (TW)

(21) Appl. No.: 13/019,082

(22) Filed: Feb. 1, 2011

(51) Int. Cl. A47B 81/00; E05D 7/00; E05D 11/06

(52) U.S. Cl. 312/319.1; 16/375; 16/362

(57) ABSTRACT

A hinge is mounted in a sliding assembly for a portable device. The hinge has a hollow pintle, a first positioning ring, a second positioning ring and a resilient element. The positioning rings are mounted around the pintle and respectively have corresponding detents and protrusions to provide positioning function. The resilient element is mounted in the pintle and is mounted between the positioning rings to reduce the length of the hinge. When the second positioning ring is rotated, the second positioning ring also moves upward to lift the supporting panel of the sliding assembly and the cover of the portable device. Therefore, the cover is kept from bumping into the expanding parts of the portable device.

### BACKGROUND OF THE INVENTION

1. Field of the Invention

The present invention relates to a hinge, especially to a hinge for a sliding assembly mounted between a cover and a base of a portable device.

2. Description of the Prior Arts

Portable devices with a cover and base are widely used in the present society. U.S. Pat. No. 7,669,286, which is incorporated herein as a reference, discloses a conventional hinge mounted between a cover and a base of a conventional portable device to allow the cover to rotate relative to the base. The conventional hinge has two positioning rings selectively rotating relative to each other. The positioning rings respectively have corresponding protrusions and detents formed on inner sides to selectively engage each other to provide positioning function. In order to keep the inner sides of the positioning rings abutting against each other, a compression spring or multiple resilient washers press the outer side of one of the positioning rings. However, the compression spring or the resilient washers increase the length of the conventional hinge so that the conventional hinge is unfavorable for manufacturing a small portable device as the current tendency demands.

Moreover, U.S. Patent Publications No. 2008/0125201, 2008/0176607, 2006/0223596, 2007/0082718, 2008/0106856, and 2008/0200222, which are incorporated herein as references, disclose a conventional sliding assembly mounted between the cover and the base of the conventional portable device to allow the cover to slide relative to the base. The conventional sliding assembly protects a keypad on the base when the conventional portable device is not used. Furthermore, when the cover is slid to open, the base should reveal the largest area to accommodate more keys or larger keys for easier utilization. It can be noted that the base and the cover in those references are the same in size and the base is flat to allow the cover to slide thereon. However, when the sizes of the base and the cover are different or the base is uneven, the conventional sliding assembly is not suitable. Additionally, an innovative sliding path of the cover is also a selling point.

To overcome the shortcomings, the present invention provides a hinge for a sliding assembly to mitigate or obviate the aforementioned problems.

### SUMMARY OF THE INVENTION

The main objective of the present invention is to provide a hinge having decreased length and lifting an object to another plane while sliding. The hinge is mounted in a sliding assembly for a portable device. The hinge has a hollow pintle, a first positioning ring, a second positioning ring and a resilient element. The positioning rings are mounted around the pintle and respectively have corresponding detents and protrusions to provide positioning function. The resilient element is mounted in the pintle and is mounted between the positioning rings to reduce the length of the hinge. When the second positioning ring is rotated, the second positioning ring also moves upward to lift the supporting panel of the sliding assembly and the cover of the portable device. Therefore, the cover is kept from bumping into the expanding parts of the portable device.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge in accordance with the present invention;

FIG. 2 is another exploded perspective view of the hinge in FIG. 1;

FIG. 3 is a perspective view of the hinge in FIG. 1;

FIG. 4 is an exploded perspective view of a first embodiment of a portable device in accordance with the present invention;

FIG. 5 is an operational perspective view of the portable device in FIG. 4, shown closed;

FIG. 6 is an operational partial perspective view of the portable device in FIG. 4, shown closed;

FIG. 7 is an operational side view of the portable device in FIG. 4, shown closed;

FIG. 8 is another operational side view of the portable device in FIG. 4, shown closed;

FIG. 9 is an operational perspective view of the portable device in FIG. 4, shown half-opened;

FIG. 10 is an operational partial perspective view of the portable device in FIG. 4, shown half-opened;

FIG. 11 is an operational side view of the portable device in FIG. 4, shown half-opened;

FIG. 12 is another operational side view of the portable device in FIG. 4, shown half-opened;

FIG. 13 is an operational perspective view of the portable device in FIG. 4, shown full-opened;

FIG. 14 is an operational partial perspective view of the portable device in FIG. 4, shown full-opened;

FIG. 15 is an operational side view of the portable device in FIG. 4, shown full-opened;

FIG. 16 is another operational side view of the portable device in FIG. 4, shown full-opened;

FIG. 17 is an exploded partial perspective view of a second embodiment of a portable device in accordance with the present invention;

FIG. 18 is an exploded perspective view of a third embodiment of a portable device in accordance with the present invention; and

FIG. 19 is an exploded partial perspective view of a fourth embodiment of a portable device in accordance with the present invention.

### DETAILED DESCRIPTION OF THE PREFERRED EMBODIMENTS

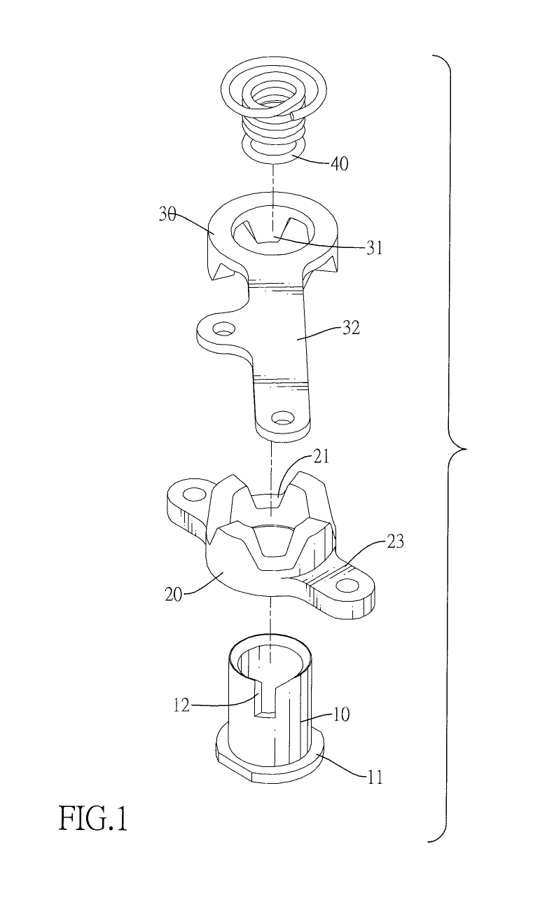

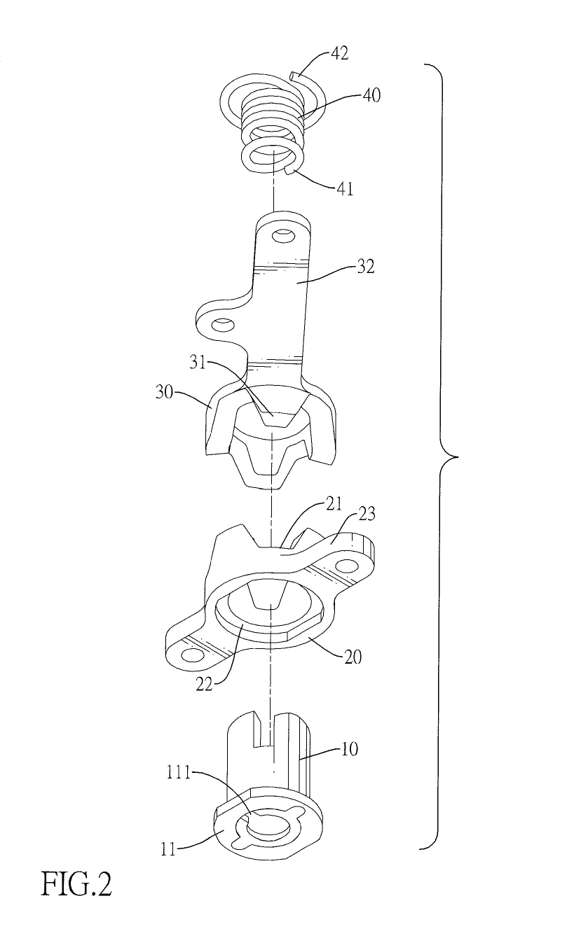

With reference to FIGS. 1 and 2, a hinge in accordance with the present invention comprises a pintle 10, a first positioning ring 20, a second positioning ring 30 and a resilient element 40.

The pintle 10 is hollow and has two end openings to allow an electrical wire mounted through. The pintle 10 has a flange 11, a gap 111 and a notch 12. The flange 11 is formed around an outside wall of the pintle 10 and may be flush with one end of the pintle 10. The gap 111 is formed on the one end of the pintle 10. The notch 12 is formed through another end of the pintle 10.

The first positioning ring 20 is mounted securely around the pintle 10 and has at least one positioning detent 21, a receiving recess 22 and two ears 23. Each positioning detent 21 is formed on a top edge of the first positioning ring 20 and has two inclined ends. In a preferred embodiment, the first positioning ring 20 has multiple positioning detents 21 formed separately at intervals. The receiving recess 22 is formed on a bottom edge of the first positioning ring 20 and engages the flange 11 of the pintle 10 to mount the first positioning ring 20 securely around the pintle 10. In a preferred embodiment, the receiving recess 22 is configured to match the shape of the flange 11 of the pintle so as to be connected firmly. The ears 23 are formed oppositely on and protrude transversely out from an outside wall of the first positioning ring 20.

The second positioning ring 30 is mounted rotatably around the pintle 10. A bottom edge of the second positioning ring 30 abuts against the top edge of the first positioning ring 20. The second positioning ring 30 comprises at least one positioning protrusion 31 and a pivoting arm 32. Each positioning protrusion 31 is formed on the bottom edge of the second positioning ring 30, selectively engages the positioning detent 21 of the first positioning ring 20 and has two inclined ends to allow the positioning protrusion 31 to easily slide in and out of the positioning detent 21. In a preferred embodiment, the second positioning ring 30 has two opposite positioning protrusions 31. The pivoting arm 32 is formed on and protrudes transversely out from an outside wall of the second positioning ring 30.

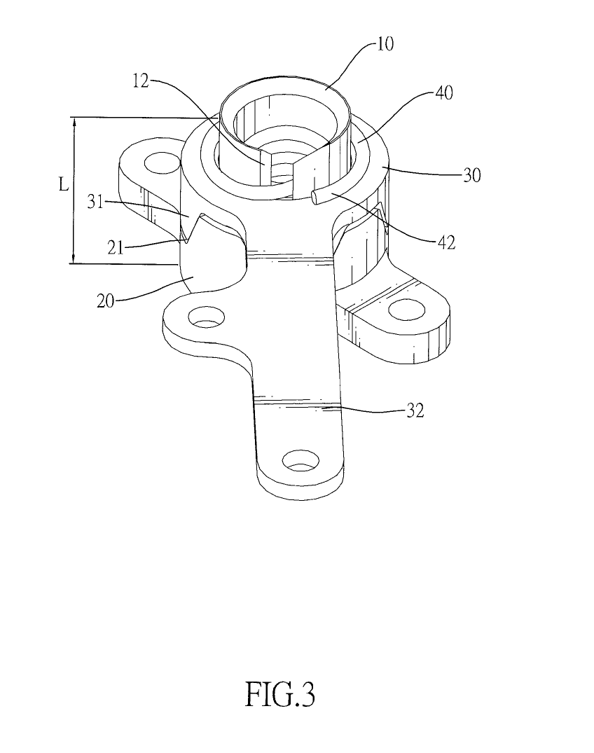

With reference to FIGS. 2 and 3, the resilient element 40 is mounted in the pintle 10 and is located between the first and second positioning rings 20, 30. The resilient element 40 has a first end 41 and a second end 42. The ends 41,42 of the resilient element 40 are respectively attached to the pintle 10 and the second positioning ring 30. In a preferred embodiment, the first end 41 of the resilient element 40 is mounted in the pintle 10 and is attached to the gap 111 of the pintle 10. The second end 42 of the resilient element 40 is mounted through the notch 12 of the pintle 10 and is mounted on a top edge of the second positioning ring 30. Thus, the resilient element 40 pulls the second positioning ring 30 at the top edge thereof to force the second positioning ring 30 to press down on the first positioning ring 20. In a preferred embodiment, the resilient element 40 is a tension spring. The second end 42 of the tension spring winds around the pintle 10 and abuts against the top edge of the second positioning spring 30.

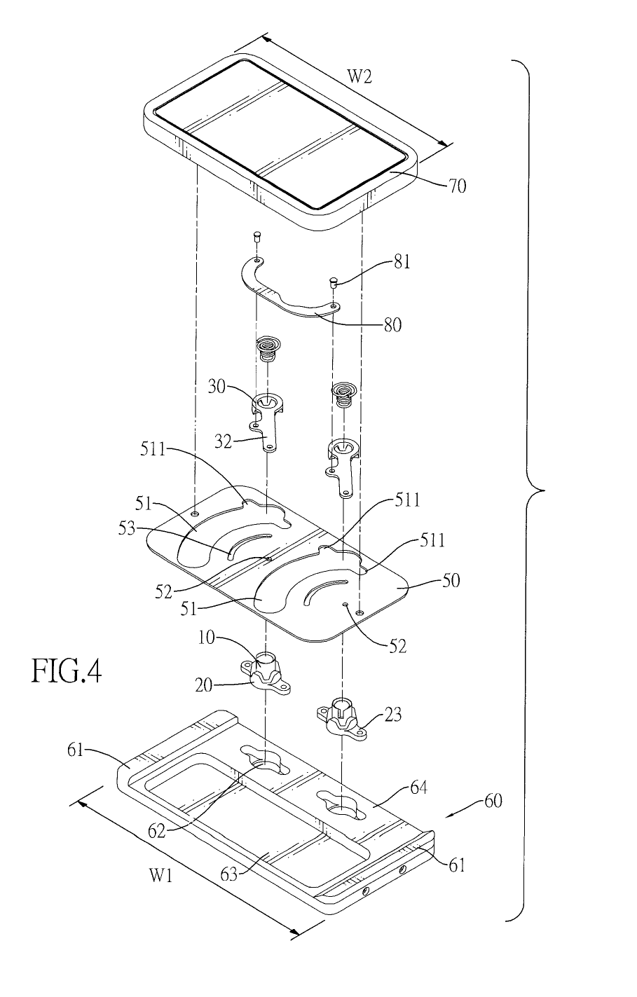

With reference to FIG. 4, a sliding assembly in accordance with the present invention comprises a supporting panel 50 and at least one hinge as described. The supporting panel 50 has at least one main channel unit. In a preferred embodiment, the supporting panel 50 has two main channel units. Each main channel unit has a main channel 51 and a pivoting hole 52. The main channel 51 is arc, is formed through the supporting channel 50 and has two ear holes 511. The ear holes 511 are formed oppositely on inside walls of the main channel 51 at one end. The pivoting hole 52 is formed through the supporting channel 50. Each main channel unit receives one hinge as described. The assembling process of the sliding assembly is described below. First, the hinges as described are assembled as shown in FIG. 3. Then the hinges as described and the ears 23 of the first positioning rings 20 pass through the main channels 51 and the ear holes 511 of the supporting channel 50. Ends of the pivoting arms 32 are pivotally connected to the pivoting holes 52. The first positioning rings 20 are located at a bottom side of the supporting panel 50. Therefore, the sliding assembly as described is accomplished.

With reference to FIG. 4, a portable device in accordance with the present invention comprises a base 60, a cover 70 and a sliding assembly as described. The base 60 has electric components therein and has two expanding parts 61, a cavity 64, a mounting area 63 and at least one mounting recess 62. The expanding parts 61 are formed oppositely on a top surface of the base 60 and are formed respectively near two ends. The expanding parts 61 may have keys or a small screen or solar-absorbing unit mounted thereon. The cavity 64 is formed on the top surface between the expanding parts 61. The mounting area 63 is formed through the top surface of the base 60 to receive input devices such as keyboards. The at least one mounting recess 62 is formed on the top surface of the base 60. The cover 70 is mounted slidably in the cavity 64 of the base 60 and has output devices mounted thereon. A width W1 of the base 60 is larger than a width W2 of the cover 70. The first positioning rings 20 of the hinges of the sliding assembly are attached securely to the base 60. The supporting panel 50 of the sliding assembly is attached securely to the cover 70. When assembling, the first positioning ring 20 is mounted in the corresponding mounting recess 62. Fasteners such as screws are easily mounted through the ear holes 511 of the supporting panel 50 and fasten the ears 23 of the first positioning ring 20 in the mounting recess 62. When the cover 70 slides relative to the base 60, the second positioning ring 30 is rotated with the supporting panel 50 relative to the first positioning ring 20.

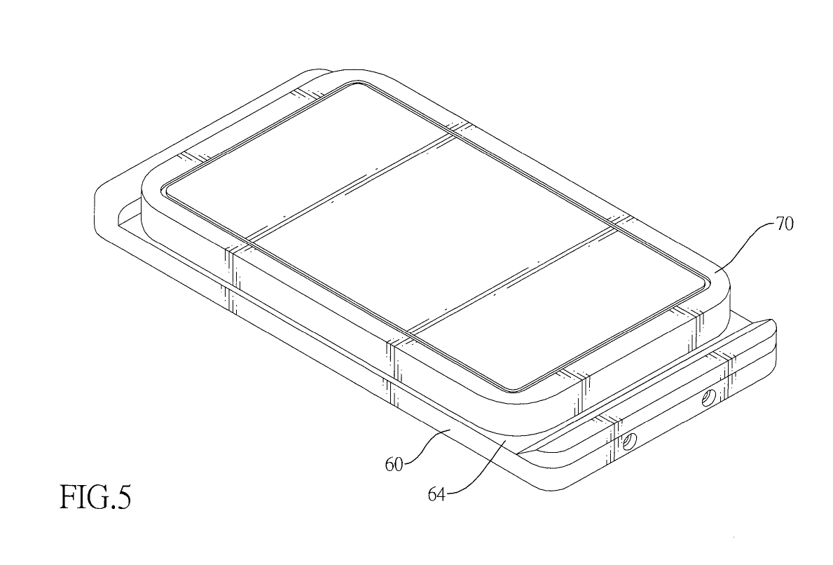

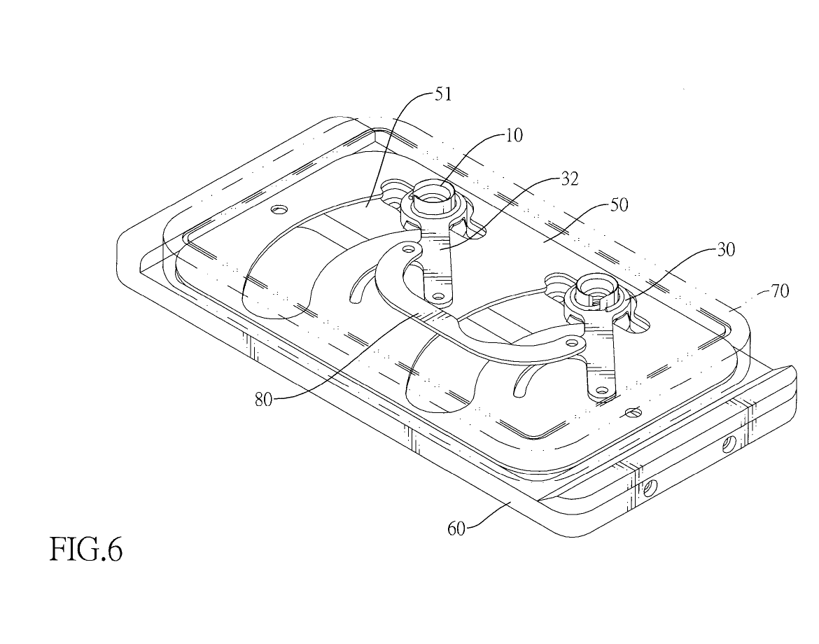

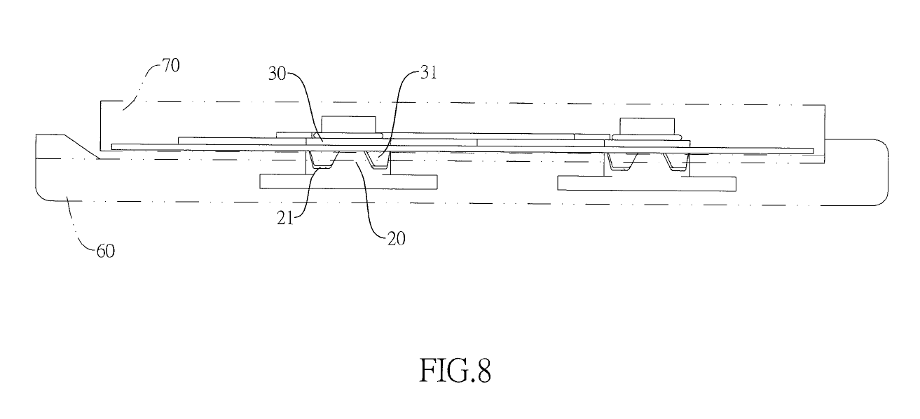

With reference to FIGS. 5 to 8, when the portable device as described is closed, the cover 70 is fully received in the cavity 64 of the base 60. The positioning detents 21 of the first positioning ring 20 respectively engage the positioning protrusion 31 of the second positioning ring 30 to provide positioning function. The pintle 10 abuts one end of the main channel 51 of the supporting panel 50. The bottom surface of the cover 70 is close to the top surface of the base 60.

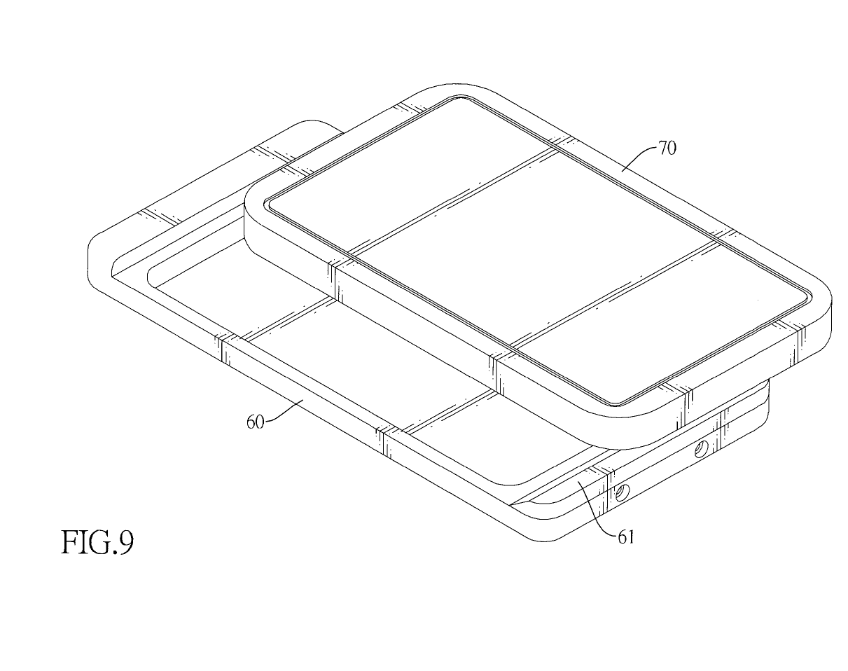

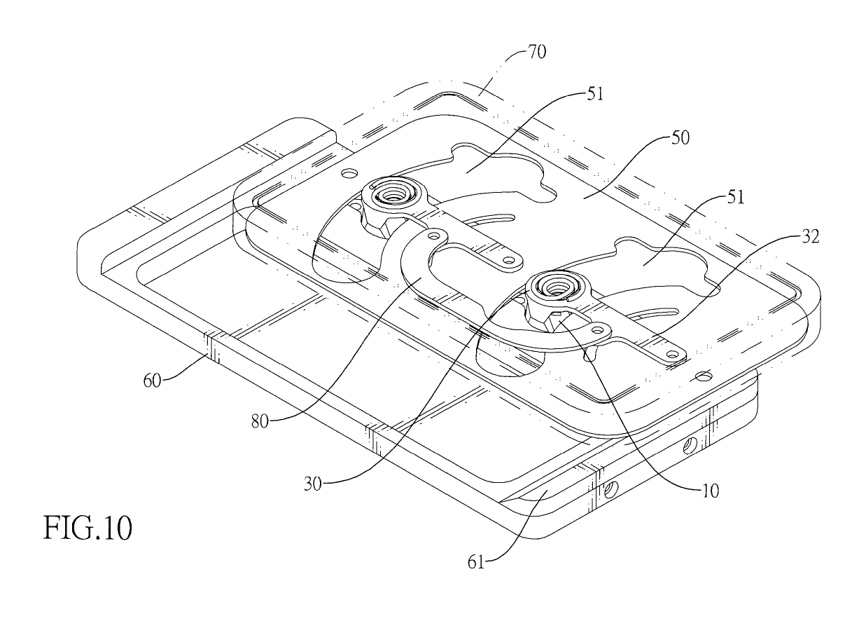

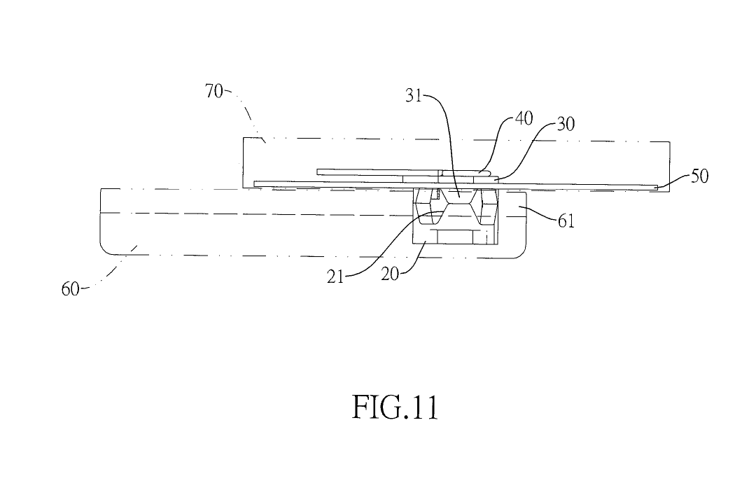

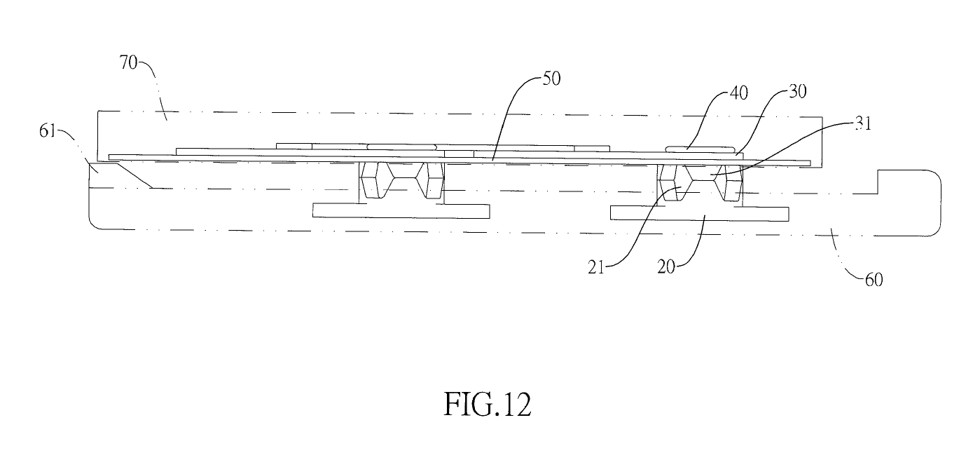

With reference to FIGS. 9 to 12, when the portable device is being opened, the cover 70 is pushed to slide the supporting panel 50 via the main channels 51 sliding relative to the pintles 10. Since the main channels 51 are arc, the sliding path of the supporting panel 50 and the cover 70 is also curved. Moreover, because the supporting panel 50 is mounted pivotally to the pivoting arms 32 of the second positioning ring 30, the pivoting arms 32 are rotated when the supporting panel 50 slides and then the second positioning ring 30 is pivoted as well. The positioning protrusions 31 disengage from the positioning detents 21 while the second positioning ring 30 is pivoted relative to the first positioning ring 20. Then the second positioning ring 30 also moves upward to lift the supporting panel 50 and the cover 70. The lifted cover 70 does not bump into the expanding parts 61 of the base 60. Furthermore, the resilience of the resilient elements 40 keeps acting on the top edges of the second positioning rings 30 to force the positioning protrusions 31 to press downward on the top edge of the first positioning ring 20.

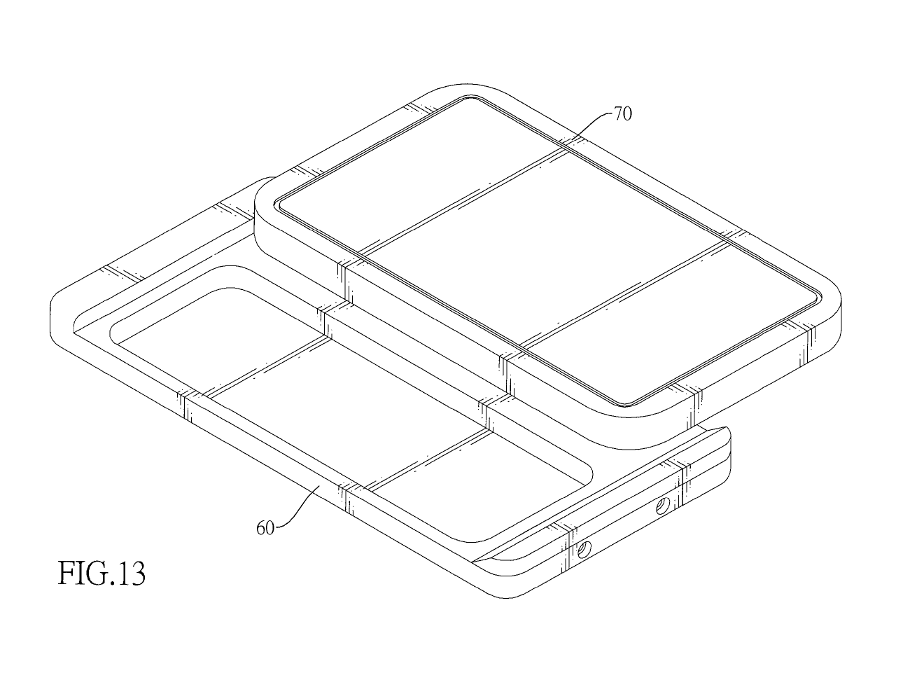

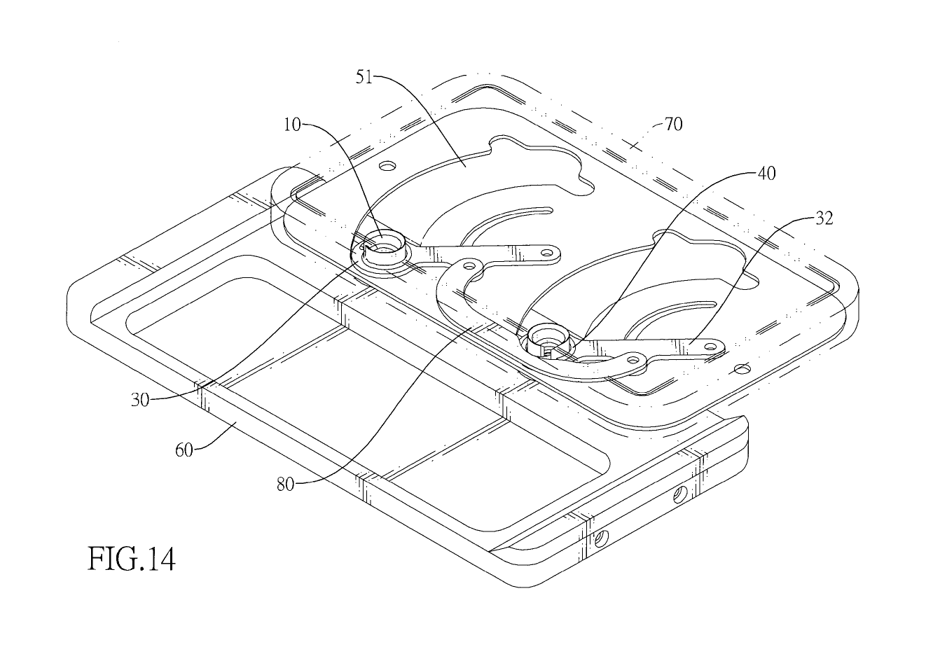

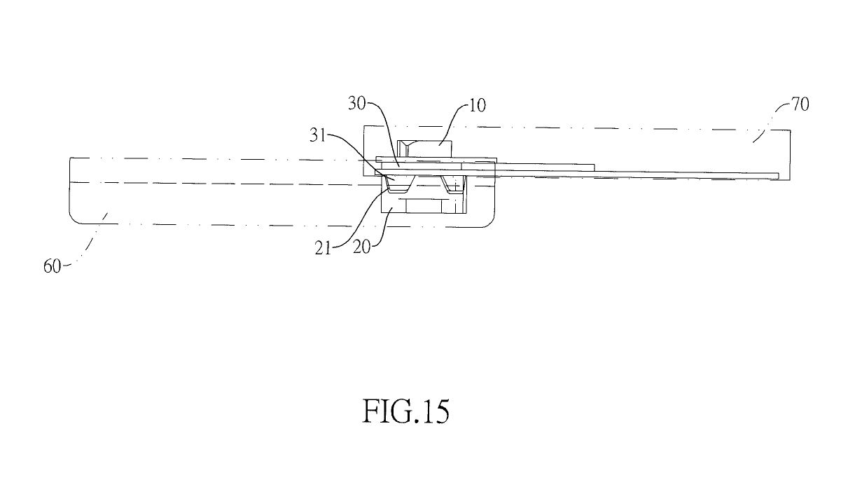

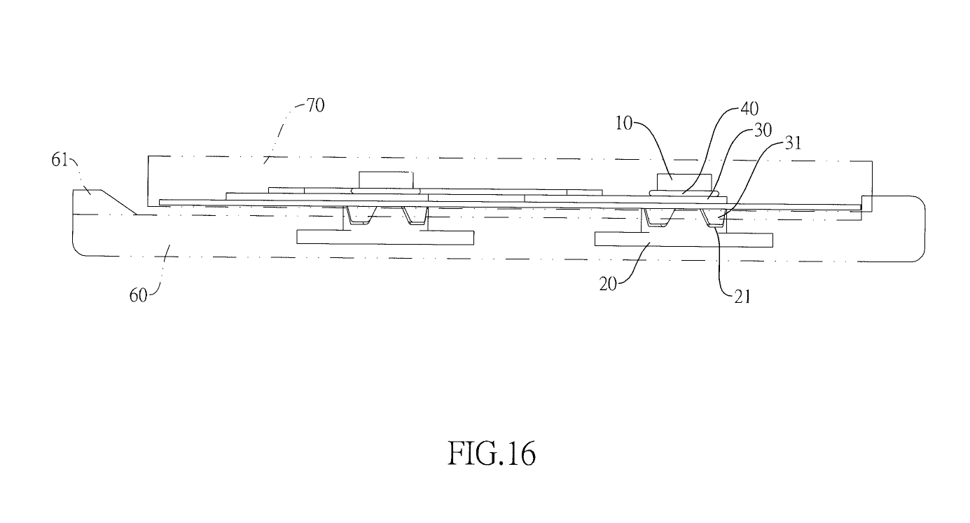

With reference to FIGS. 13 to 16, the cover 70 is kept pushed until the portable device as described is fully opened. The supporting panel 50 keeps sliding until the pintle 10 abuts another end of the main channel 51. The pivoting arms 32 keep pivoting until the positioning protrusions 31 correspond to the positioning detents 21 again. Since the resilience of the resilient elements 40 keeps acting on the top edges of the second positioning rings 30, the second positioning rings 30 are pressed downward to engage the positioning protrusions 31 and the positioning detents 21 to provide positioning function. Thus, the cover 70 returns to the original plane and the portable device as described is fully opened.

The sliding assembly and the portable device as described have different embodiments as following disclosed.

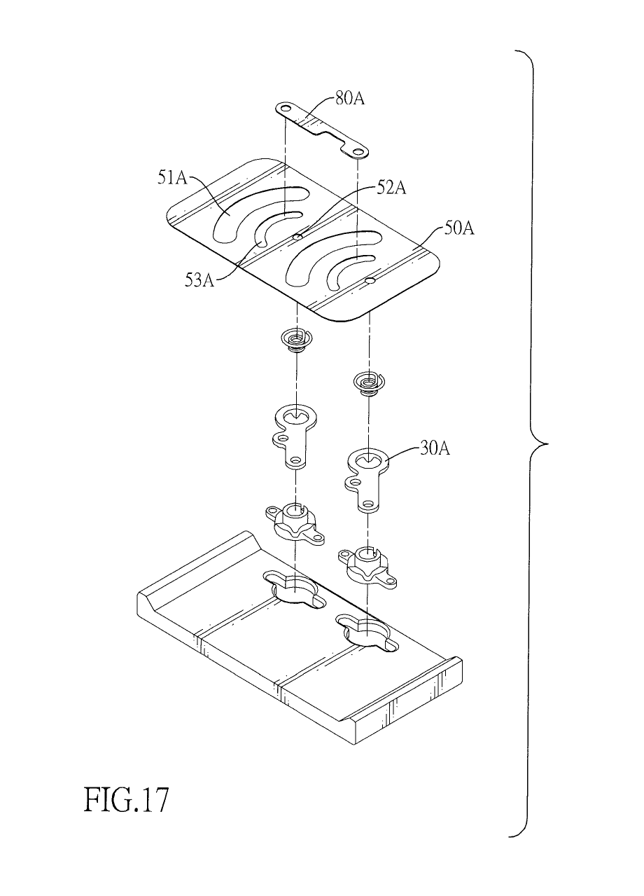

In a preferred embodiment as shown in FIGS. 4 and 17, the sliding assembly as described has two hinges and further comprises a connecting arm 80, 80A. The base 60 has two mounting recesses 62 to receive the first positioning rings 20 of two hinges. The supporting panel 50 has two main channel units parallel to each other. Each main channel unit further has an arc secondary channel 53, 53A parallel to the main channel 51, 51A. Each secondary channel 53, 53A is formed between the main channel 51, 51A and the pivoting hole 52, 52A of the main channel unit. The second positioning ring 30 may be located above the supporting panel 50 as shown in FIG. 4, or the second positioning ring 30A may be located under the supporting panel 50A. Two ends of the connecting arm 80, 80A are respectively connected pivotally to the second positioning rings 30, 30A of the two hinges. When the supporting panel 50, 50A slides, the second positioning rings 30, 30A are rotated simultaneously via the connecting arm 80, 80A. In a preferred embodiment, two pins 81 are respectively mounted slidably through the secondary channels 53 to pivotally mount the connecting arm 80 and the second positioning rings 30. The connecting arm 80 may be U-shaped as shown in FIG. 4, or the connecting arm 80A may be elongated as shown in FIG. 17. When the supporting panel 50 slides, the two hinges simultaneously lift the cover 70 to allow the cover 70 to smoothly rotate and slide relative to the base 60.

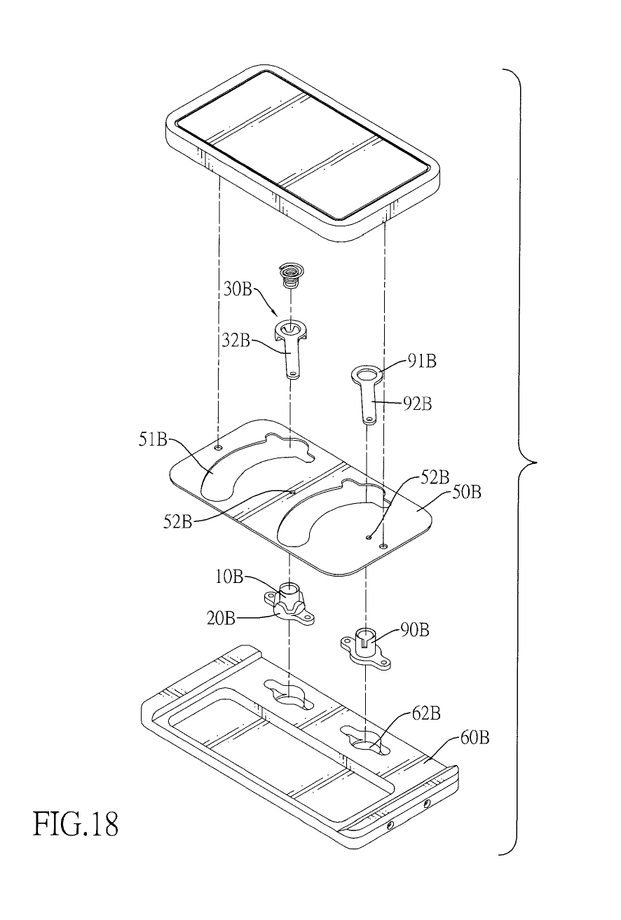

In a preferred embodiment as shown in FIG. 18, the sliding assembly as described has a single hinge and further has an auxiliary pintle 90B, an auxiliary pivoting ring 91B and an auxiliary pivoting arm 92B. The auxiliary pivoting ring 91B is mounted rotatably around the auxiliary pintle 90B. The auxiliary pivoting arm 92B is formed on and protrudes transversely out from an outside wall of the auxiliary pivoting ring 91B. The supporting panel 50B has two main channel units parallel to each other. The second positioning ring 30B is located above the supporting panel 50B. The hinge 10B and the auxiliary pintle 90B are respectively mounted through the main channels 51B. The base 60B has two mounting recesses 62B. The first positioning ring 20B and the auxiliary pintle 90B respectively engage the mounting recesses 62B. The pivoting arm 32B and the auxiliary pivoting arm 92B are respectively connected pivotally to the pivoting holes 52B. When the supporting panel 50B slides, the hinge lifts the cover, and the auxiliary pintle 90B and the auxiliary pivoting arm 92B balance the supporting panel 50B to keep the supporting panel 50B from shaking.

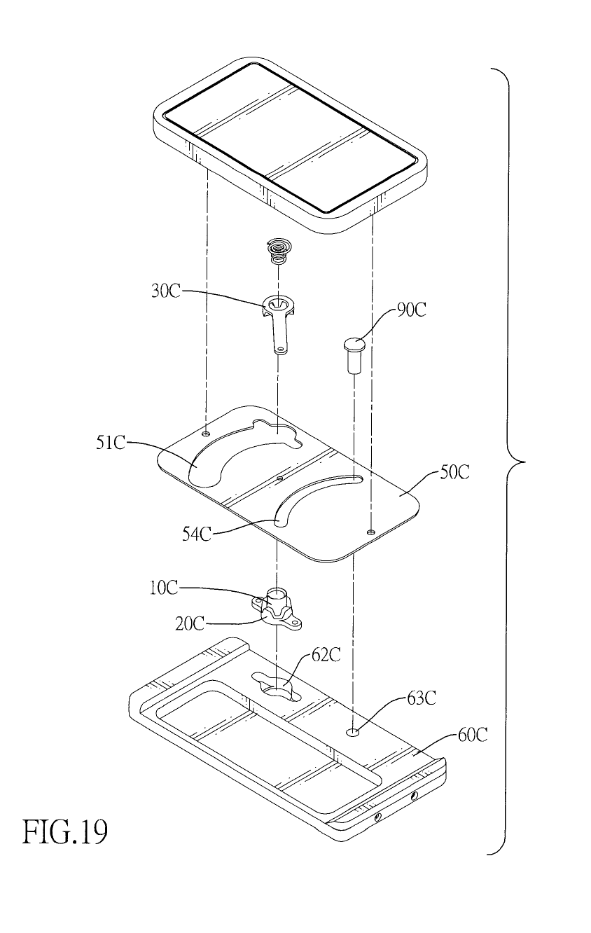

In a preferred embodiment as shown in FIG. 19, the sliding assembly as described has a single hinge and further has an auxiliary pintle 90C. The supporting panel 50C has a main channel unit and an auxiliary channel 54C. The auxiliary channel 54C is formed through the supporting panel 50C and is parallel to the main channel 51C. The base 60C has a mounting recess 62C and a pinhole 63C formed through the top surface. The first positioning ring 20C engages the mounting recess 62C. The auxiliary pintle 90C is mounted through the auxiliary channel 54C and is mounted securely in the pinhole 63C. When the supporting panel 50C slides, the hinge lifts the cover and the auxiliary pintle 90C sliding in the auxiliary channel 54C balances the supporting panel 50C to keep the supporting panel 50C from shaking.

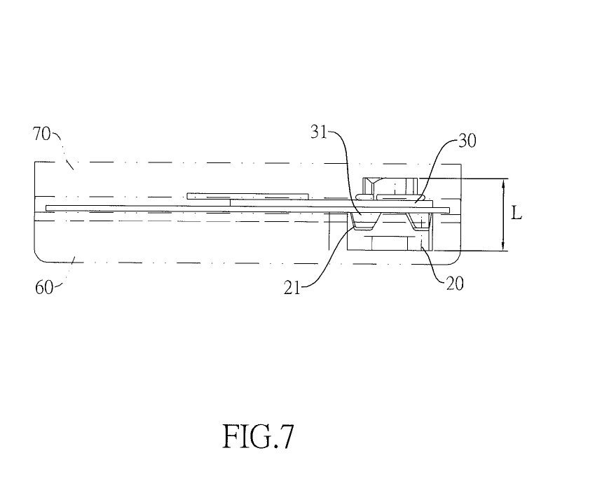

Although the positioning rings are also used in the present invention to provide positioning function, the positioning rings in the present invention are different from the positioning rings disclosed in the prior art such as U.S. Pat. No. 7,669,286. In the prior art, a resilient element is used to press on the outer side of one of the positioning rings to force the positioning rings to abut against each other on the inner sides. However, in the present invention, the resilient element 40 is mounted in the pintle 10 and extends out of the pintle 10 to press on the top edge of the second positioning ring 30. With reference to FIGS. 3 and 7, the full length L of the hinge as described is shortened and thus the portable device will be flatter accordingly.

Furthermore, with the hinge lifting the cover when the cover slides, the cover is kept from bumping into the expanding parts 61. Therefore, the expanding parts 61 may have keys or a small screen mounted thereon to enhance the functions of the portable device as described.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a hollow pintle;
a first positioning ring mounted securely around the pintle and having at least two positioning detents formed on a top edge of the first positioning ring;
a second positioning ring mounted rotatably around the pintle and having
a bottom edge abutting against the top edge of the first positioning ring; and
at least one positioning protrusion formed on the bottom edge of the second positioning ring, selectively engaging the positioning detent of the first positioning ring; and
a resilient element mounted in the pintle and having a first end and a second end, and the two ends respectively attached to the pintle and the second positioning ring to urge the second positioning ring toward the first positioning ring.

2. The hinge as claimed in claim 1, wherein
the pintle has a notch formed through a top end and the outside wall of the pintle;
the resilient element is a tension spring; and
the second end of the resilient element mounted through the notch, winding around the pintle and abuts against the top edge of the second positioning ring.

3. The hinge as claimed in claim 1, wherein
the pintle has a flange formed around an outside wall of the pintle; and
the first positioning ring has a receiving recess formed on a bottom edge of the first positioning ring and engaging the flange of the pintle.

4. The hinge as claimed in claim 1, wherein
each positioning detent of the first positioning ring has two inclined ends; and
each one of the at least one positioning protrusion of the second positioning ring has two inclined ends.

5. The hinge as claimed in claim 1, wherein the first positioning ring has two ears formed oppositely on and protruding transversely out from an outside wall of the first positioning ring.

6. A sliding assembly with at least one hinge as claimed in claim 1, wherein
the sliding assembly comprises a supporting panel having at least one main channel unit, and each one of the at least one main channel unit having
an arc main channel formed through the supporting panel; and
a pivoting hole formed through the supporting panel;
the pintle of each one of the at least one hinge is mounted through a corresponding main channel;
the first positioning ring of each one of the at least one hinge is located under the supporting panel; and
each one of the at least one hinge further comprising a pivoting arm formed on and protruding transversely out from an outside wall of the second positioning ring and connected pivotally to a corresponding pivoting hole.

7. A portable device with a sliding assembly as claimed in claim 6, wherein
the portable device comprises
a cover; and
a base that is wider than and connecting slidably to the cover and having
two expanding parts formed oppositely on a top surface of the base and formed respectively near two ends; and
a cavity formed on the top surface of the base and formed between the expanding parts;
the first positioning ring of each one of the at least one hinge is attached securely to the base; and
the supporting panel is attached securely to the cover.

8. The portable device as claimed in claim 7, wherein
the sliding assembly has the two hinges;
the base has two mounting recesses;
the first positioning rings of the two hinges are respectively mounted in the mounting recesses of the base;
the supporting panel has two main channel units parallel to each other; wherein each main channel unit further comprises an arc secondary channel formed between the main channel and the pivoting hole; and
the sliding assembly further comprises a connecting arm having two ends pivotally connected to the pivoting arms of the second positioning rings of the two hinges and the two ends of the connecting arm sliding respectively in the secondary channels.

9. The portable device as claimed in claim 8 further comprising two pins respectively mounted slidably through the secondary channels to pivotally connect the connecting arm and the second positioning rings.

10. The portable device as claimed in claim 7, wherein
the sliding assembly has a single hinge;
the supporting panel has two main channel units parallel to each other;
the base has two mounting recesses; and
the sliding assembly further comprises
an auxiliary pintle, wherein the auxiliary pintle and the first positioning ring are respectively mounted in the mounting recesses of the base;
an auxiliary pivoting ring mounted rotatably around the auxiliary pintle; and
an auxiliary pivoting arm formed on and protruding transversely out from an outside wall of the auxiliary pivoting ring, wherein the auxiliary pivoting arm and the pivoting arm of the hinge are respectively connected pivotally to the pivoting holes of the two main channel units.

11. The portable device as claimed in claim 7, wherein
the sliding assembly has a single hinge;
the supporting panel has a single main channel unit and further comprises an auxiliary channel formed through the supporting panel and parallel to the main channel;
the base has a single mounting recess and further comprising a pinhole formed through the top surface of the base; and
the sliding assembly further comprises an auxiliary pintle mounted through the auxiliary channel and mounted securely in the pinhole.

12. The portable device as claimed in claim 8, wherein the second positioning ring of each hinge is located under the supporting panel.

13. The portable device as claimed in claim 8, wherein the second positioning ring of each hinge is located above the supporting panel.

14. The portable device as claimed in claim 8, wherein the connecting arm is U-shaped.

15. The portable device as claimed in claim 8, wherein the connecting arm is elongated.

16. A portable device comprising:
a base;
a first positioning ring mounted securely on the base and having a hollow pintle formed at a center of the first positioning ring and at least two positioning detents formed on a top edge of the first positioning ring;
a second positioning ring mounted rotatably around the pintle and having
a bottom edge abutting against the top edge of the first positioning ring;
at least one positioning protrusion formed on the bottom edge of the second positioning ring, selectively engaging the positioning detent of the first positioning ring; and
a pivoting arm formed on and protruding transversely out from an outside wall of the second positioning ring;
a supporting panel having a main channel unit, and each main channel unit having
an arc main channel formed through the supporting panel; and
a pivoting hole formed through the supporting panel; and
a cover attached securely to the supporting panel, wherein
the pintle is mounted through the main channel, the pivoting arm connected pivotally to the pivoting hole, and when the cover is opened relative to the base, the cover is lifted and slides curvedly.

17. The portable device as claimed in claim 16 further comprising a resilient element mounted in the pintle and urging the second positioning ring toward the first positioning ring.

18. The portable device as claimed in claim 17, wherein the resilient element is a tension spring having a first end mounted through and attached to the pintle and a second end abutting the second positioning ring.

19. The portable device as claimed in claim 16 further comprising a first positioning ring and a second positioning ring mounted on the base, wherein
the supporting panel further has a main channel unit, and the two main channel units are parallel to each other;
each pintle of the first positioning ring is mounted through a corresponding main channel; and
each pivoting arm is connected pivotally to a corresponding pivoting hole.
